(19) United States
(12) Patent Application Publication
(10) Pub. No.: US 2005/0005988 A1
(43) Pub. Date: Jan. 13, 2005

(54) Flexible wall for containing a fluid under pressure pipe comprising samd and use thereof

(76) Inventor: Thierry Pasquet, rue Charles Peguy (FR)

Correspondence Address: Leo H McCormick Jr, 2112 Mishawaka Avenue, P O Box 4721, South Bend, IN, 46634-4721, US

(21) Appl. No.: 10/481,655

(22) PCT Filed: Jun. 19, 2002
(86) PCT No.: PCT/FR02/02115

(30) Foreign Application Priority Data
Jun. 21, 2001 (FR) 01/08304

(51) Int. Cl. F16L 11/00

(52) U.S. Cl. 138/126; 138/125

(57) ABSTRACT

A flexible hose having a wall comprising at least one interlayer (3, 4), to ensure mechanical strength, and two sealing layers (1, 2) lying one on each side of the interlayer. The wall includes an intermediate ply (5) of wires made of a shape-memory material that are arranged and oriented so that their contraction, when the temperature rises, opposes the mechanical deformation of the wall under the effect of pressure.

The invention relates to a flexible wall for containing a pressurized fluid in a volume, this wall comprising at least one interlayer, to ensure mechanical strength, and two surface layers lying one on each side of the interlayer, to ensure sealing.

### BACKGROUND OF THE INVENTION

The invention relates more particularly, but not exclusively, to a flexible wall for containing a pressurized liquid in a motor-vehicle braking system.

When a fluid, in particular a pressurized liquid, is imprisoned in a container, the wall defining this container is subjected to deformations due to the pressure of the fluid. These deformations cause variations in the internal volume of the container.

For some applications, it is desirable to limit or control such volume variations. For example, in a hydraulic braking system, the volume deformation of the lines due to the pressure causes a liquid absorption phenomenon and less effective braking control.

It is furthermore desirable to be able to estimate the value of the internal pressure from the deformation of the wall.

### SUMMARY OF THE INVENTION

The object of the invention is, above all, to provide a wall composed of several layers which, while being more pressure-resistant, makes it possible to act against this deformation.

According to the invention, a flexible wall for containing a pressurized fluid, especially for a motor-vehicle braking system, comprising at least one interlayer, to ensure mechanical strength, and two sealing layers lying one on each side of the interlayer, is characterized in that it includes an intermediate ply of wires made of a shape-memory material that are arranged and oriented so that their contraction, when the temperature rises, opposes the mechanical deformation of the wall under the effect of pressure.

Preferably, the intermediate ply of wires made of a shape-memory material consists of a braid.

Advantageously, electrical couplers are provided on opposed edges of the braid in order to allow an electrical current to flow therein for the purpose of heating it.

The invention also relates to a hose, in particular for a hydraulic circuit, the wall of which is as defined above.

The intermediate ply of wires made of a shape-memory material comprises wires that are inclined with respect to the generatrices of the hose so as to have a component in the hoop direction. This intermediate ply advantageously consists of a braid.

Preferably, the hose includes an external layer and an internal layer made of an elastomer, especially a rubber, to ensure sealing. The ply of wires made of a shape-memory material may be between two layers ensuring mechanical strength, these being formed in particular by braids made of nylon yarn.

A length of hose may be provided at; each end with a hydraulic coupler and with an electrical coupler electrically connected to the corresponding end of the braid made of a shape-memory material.

Advantageously, the intensity of the electrical current flowing through the shape-memory braid is adjusted and controlled according to the absorption law desired for the hose.

A calibrated-drop delivery system may be produced with such a hose. The delivery system comprises a reservoir of pressurized liquid placed above a length of hose whose braid made of a shape-memory material is connected, at each of its ends, to a terminal of an electrical voltage source; the lower end of the length of hose is connected to a drop delivery nozzle. By adjusting the intensity of the current flowing through the braid it is possible to vary the size of the drops delivered.

A hydraulic accumulator may be bounded by a flexible wall according to the invention, the deformations of which are controlled by the intensity of the electrical current flowing through the layer made of a shape-memory material.

The invention consists, apart from the arrangements mentioned above, of a number of other arrangements which will be explained in greater detail below with regard to illustrative examples which are described with reference to the drawings appended hereto.

### BRIEF DESCRIPTION OF THE DRAWINGS

FIG. 1 is an axial section of a length of hose according to the invention;

FIG. 2 is a perspective view of one end of the hose whose various layers have been stripped;

FIG. 3 is a schematic section of the end of a hose provided with a hydraulic and electrical coupler;

FIG. 4 is a schematic perspective view of that end of the hose of FIG. 3 which is provided with the hydraulic and electrical coupler;

FIG. 5 is a schematic sectional view of the embodiment of the electrical connection;

FIG. 6 is a graph illustrating the variations ΔV of a volume closed by a wall according to the invention; the volume values are plotted on the y-axis, the pressure being plotted on the x-axis on the right-hand side and the intensity of the electrical current flowing through the braid being plotted on the left-hand side;

FIG. 7 is a diagram of a calibrated-drop delivery system; and

FIG. 8, finally, is a sectional diagram of a hydraulic accumulator bounded by a wall according to the invention.

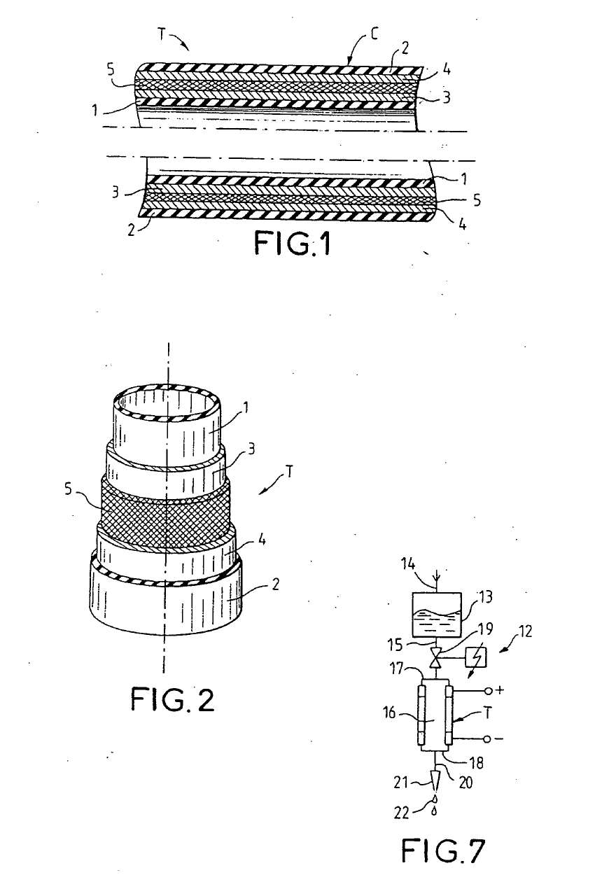

### DETAILED DESCRIPTION OF THE INVENTION

In the drawings, especially FIG. 1, there may be seen a hose T intended to conduct a pressurized fluid, in particular a motor-vehicle brake fluid, the wall C of which is composed of several layers. The thicknesses of the various layers in the drawings have been increased in order to make examination easier, and do not correspond to reality.

An internal layer 1 seals against the fluid flowing inside the hose T and protects the other layers from this fluid. The layer 1 is made, for example, of an elastomer, especially a rubber. An external layer 2 also provides sealing and protection of the internal layers. This external layer 2 may also be made of an elastomer, especially a rubber.

Provided around the internal layer 1 is a layer 3 ensuring mechanical resistance to the pressure of the fluid flowing in the hose T. This layer 3 may be formed from a braid of a yarn made of a material having good mechanical strength, for example a braid made of a nylon yarn or a yarn of another equivalent material. Preferably, a layer 4, similar to the layer 3, is provided against the external layer 2, on the inside of the latter. The layer 4 may also be formed from a braid of a yarn made of a mechanically resistant material, especially a braid of nylon yarn.

Placed between the layers 3 and 4 is an intermediate ply 5 of wires made of a shape-memory material that are oriented and arranged so as to oppose mechanical deformation of the wall C under the effect of pressure, by their contraction when the temperature rises.

As an example of a shape-memory material, mention may be made of Ni—Ti alloys, this example not being restrictive.

It will be recalled that a wire made of a shape-memory material tends to contract when its temperature rises, especially when an electrical current flows through the wire and heats it by the Joule effect. It recovers its initial state when returning to its initial temperature.

To exploit this contraction effect, and oppose the deformation, essentially the swelling of the hose T under the effect of the pressure, it is necessary for the ply 5 to have wires inclined to the generatrices of the hose so as to have a component in the hoop direction, that is to say in a plane perpendicular to the axis of the hose. Preferably, the ply 5 is produced in the form of a braid of shape-memory wires so that the abovementioned condition is satisfied.

The hose T, if it is conducting a hot liquid, allows the flow rate of the liquid to be automatically adapted according to the temperature. This is because, if the flow rate of the hot liquid has a tendency to increase, the braid 5 of wires made of a shape-memory material tends to contract and reduce the inside diameter of the hose, and therefore to reduce the flow rate. On the other hand, if the flow rate of hot liquid inside the hose has a tendency to decrease, the braid 5 tends to cool and therefore expand, with a reduction in the head loss and an increase in the flow rate.

In order to better control the behaviour of the hose T and, if necessary, modify its deformation law, an electrical connection allowing an electrical current to flow into the braid 5 is provided on opposed edges, as partly illustrated in FIGS. 4 and 5.

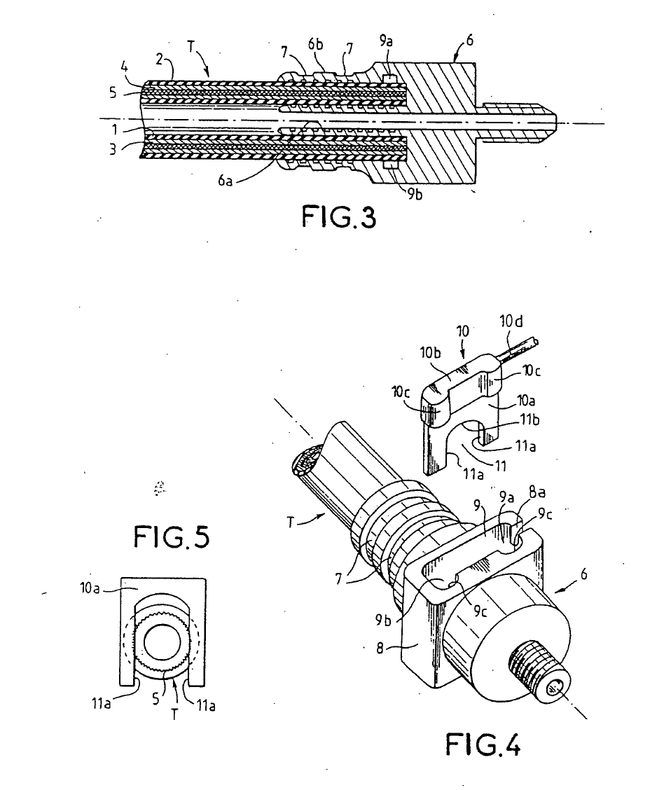

FIG. 3 shows, in axial section, one end of a length of hose T on which a male hydraulic coupler 6 has been fixed, this hydraulic coupler also allowing an electrical connection as illustrated in FIG. 4 to be made. In order for it to be mechanically fixed to one end of the hose T, the coupler 6 comprises an internal tubing 6a, which engages in the hose T, and a sleeve 6b that surrounds the hose T and is crimped onto the latter in annular regions 7.

The coupler 6 includes, as may be seen in FIG. 4, a prismatic extension 8 in a direction perpendicular to the plane of section in FIG. 3. A housing 9 is provided in this extension 8, the end of the length of hose T passing through this housing. The housing 9 has, on each side, a groove 9a, 9b orthogonal to the plane of section in FIG. 3, which opens towards the outside via a widened region 9c (FIG. 4).

A connector 10 is provided for fitting into the housing 9. The connector 10 comprises an electrically conducting metal blade 10a, especially made of copper or a copper alloy, having a recess 11 whose concavity faces towards the inside of the housing 9. The recess 11 has two parallel straight flanks 11a with cutting edges suitable for cutting the layers 2 and 4 of the hose T in order to come into contact with the braid 5. The bottom 11b of the recess is of semicircular shape. The distance between the flanks 11a is equal to the outside diameter of the blade 5 made of a shape-memory material reduced by an amount such that a satisfactory contact is established between the flanks 11a and the braid 5. The upper end of the blade 10a is set into a base 10b made of an insulating material, especially a plastic, of substantially parallelepipedal shape and having, at each longitudinal end, an excrescence 10c suitable for being housed in the widened region 9c of the grooves 9a, 9b.

An electrical cable 10d, the conducting core (not visible) of which is electrically connected to the blade 10a, allows connection to an electrical power supply. A recess 8a is provided in the extension 8 for passage of the cable 12.

The other end (not shown) of the length of hose T is equipped in the same way with a mechanical and electrical coupler similar to the coupler 6.

It is thus possible to make an electrical current flow in the braid 5 from one end of the length to the other by connecting the cables 10d of the said ends to the two terminals of an electrical power supply.

By varying the intensity of the current flowing in the braid 5, it is possible to modify the deformation law for the diameter of the hose T according to the pressure and to modify the head loss in the hose.

The invention allows the volume of the hose T and its apparent impedance to be modified. It becomes possible to adapt the absorption or the impedance of a hydraulic circuit comprising hoses according to the invention.

The pressure in the hose T may be estimated by measuring the electrical resistance of the braid 5 or the intensity of the current flowing in this braid under a given voltage. This is because the elongation of the wires making up the braid 5, under the effect of the internal pressure in the hose, causes a variation in the resistance of these wires and therefore in the current flowing through them, for a constant voltage. It is therefore possible to monitor the pressure variations in the hose and estimate the instantaneous value of the pressure from a known initial value.

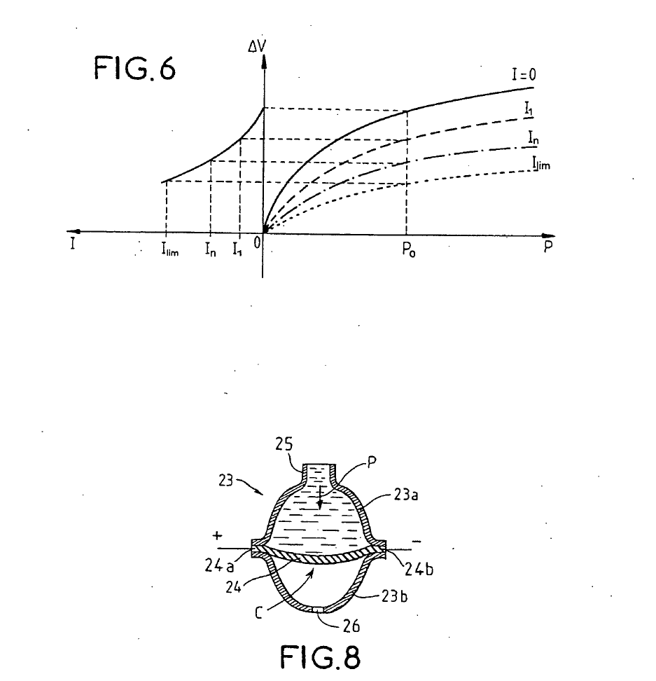

FIG. 6 is a graph illustrating, in the right-hand quadrant, the variation ΔV of the internal volume of a container, for example a length of hose, bounded by a wall C according to the invention, as a function of the pressure P of the fluid (plotted on the x-axis), normally a liquid, which fills the container. Curves I=0, I₁, Iₙ and Iₗᵢₘ (=Iₗᵢₘᵢₜ) illustrate these variations for various values of the intensity of the electrical current flowing in the braid 5.

I=0 corresponds to a zero intensity and the bold line represents the natural deformation of the hose.

Iₗᵢₘ corresponds to the maximum permissible value of the electrical current in the braid 5. The corresponding curve indicates the smaller volume variations as a function of pressure.

I₁ and Iₙ are current values of greater than 0.

For a value Pₒ of the pressure, the variation in the volume of the container decreases when the current flowing through the braid 5 goes from the zero value to the value Iₗᵢₘ.

The left-hand quadrant of FIG. 6 gives the variations ΔV of the volume plotted on the y-axis as a function of the intensity of the current flowing through the braid 5, which is plotted on the x-axis. The values I=0, I₁, Iₙ and Iₗᵢₘ are again indicated.

FIG. 7 illustrates schematically the use of a hose according to the invention in a calibrated-drop delivery system 12. The delivery system 12 comprises, at the top, a reservoir 13 of pressurized liquid, for example liquid pressurized by compressed air introduced via a line 14 running into the cover that closes the reservoir 13. A line 15 leaves the bottom of the reservoir in order to conduct the liquid into a closed volume 16, the cylindrical wall of which consists of a length of hose T according to the invention. A cover 17 and a bottom 18, both shown schematically, close off the ends of the volume 16. A solenoid valve 19, with its electrical control, is mounted on the line 15 which runs through the cover 17. A tubing 20 goes from the bottom 18 as far as a nozzle 21.

The axial ends of the braid 5 made of a shape-memory material of the hose T are electrically connected to a + terminal and to a − terminal of an electrical voltage source.

When the volume 16 has been filled with liquid by opening the solenoid valve 19, an electrical current is made to flow in the braid 5 of the hose T, causing it to heat up. The hose T undergoes a contraction which depends on the intensity of the current. The volume of the drops 22 delivered by the nozzle 21 depends in particular on the stiffness of the hose T, and therefore on the intensity of the current flowing through the braid 5, the said volume being virtually independent of the viscosity of the liquid to be delivered.

FIG. 8 illustrates a use of a wall C according to the invention for a hydraulic accumulator 23, for example of approximately spherical shape, obtained by joining two cups 23a, 23b together along an equatorial plane. A separating partition 24, cut from a piece of wall C is sealably clamped in the equatorial plane in which the two cups are joined. The pressurized liquid is introduced via a tubing 25 emerging at the top of the upper cup. Opposed edges 24a, 24b of the wall 24 are connected to two terminals of an electrical power supply. By varying the intensity of the current flowing through the braid made of a shape-memory material of the wall 24, it is possible to modulate the pressure of the liquid in the accumulator.

The volume variation in the accumulator may thus be provided by the wall 24, without having recourse to a volume of compressible gas which would be contained in the cup 23b, on the opposite side of the wall to the liquid. The internal volume of the cup 23b communicates with the atmosphere via an orifice 26.

Apart from the applications already mentioned, the invention allows the pressure in hydraulic braking systems to be regulated and affords the possibility of modifying the resonance parameters (wave reflection) in a hydraulic control line, as a hydraulic “tuner” would do.

1. A flexible wall for containing a pressurized fluid in a volume, this wall comprising at least one interlayer (3, 4), to ensure mechanical strength, and two sealing layers (1, 2) lying one on each side of the interlayer, characterized in that it includes an intermediate ply (5) of wires made of a shape-memory material that are arranged and oriented so that their contraction, when the temperature rises, opposes the mechanical deformation of the wall under the effect of pressure.

2. The wall according to claim 1, characterized in that the intermediate ply of wires made of a shape-memory material consists of a braid (5).

3. The wall according to claim 2, characterized in that electrical couplers (6, 10) are provided on opposed edges of the braid (5) in order to allow an electrical current to flow therein.

4. A hose, in particular for a hydraulic circuit, having a wall according to claims 1.

5. The hose according to claim 4, characterized in that the intermediate ply (5) of wires made of a shape-memory material comprises wires that are inclined with respect to the generatrices of the hose so as to have a component in the hoop direction.

6. The hose according to claim 5, characterized in that the intermediate ply of wires made of a shape-memory material consists of a braid (5).

7. The hose according to claim 6, characterized in that it includes an external layer (2) and an internal layer (1) made of an elastomer, especially a rubber, to ensure sealing.

8. The hose according to claim 6, characterized in that the braid (5) of wires made of a shape-memory material is between two layers (3, 4) ensuring mechanical strength, these being formed in particular by braids made of nylon yarn.

9. The hose according to claims 8, characterized in that it is provided at each end with a hydraulic and electrical coupler (6, 10) electrically connected with the corresponding end of the braid (5) made of a shape-memory material.

10. The hose according to claim 9, characterized in that the hydraulic and electrical coupler (6, 10) includes a prismatic extension (8) in which a housing (9) is provided, the end of the hose (T) passing through the said housing, and a connector (10) designed to fit into the housing (9), this connector comprising a metal blade (10a) having a recess (11) with flanks having cutting edges suitable for cutting layers (2, 4) of the hose (T) in order to come into contact with the braid (5).

11. The hose according to claim 10, characterized in that it is connected at each end to a terminal of an electrical power supply and in that the intensity of the electrical current flowing through the shape-memory braid is adjusted and controlled according to the absorption law desired for the hose.

12. A use of a hose according to claims 11, in a motor-vehicle braking system.

13. The use of a hose according to claims 11 in a calibrated-drop delivery system, characterized in that the delivery system (12) comprises, at the top, a reservoir (13) of pressurized liquid, in that a line (15) leaves the bottom of the reservoir in order to conduct the liquid into a closed volume (16), the cylindrical wall of which consists of a length of hose (T), a cover (17) and a bottom (18) closing off the ends of the volume (16), a solenoid valve (19) being mounted on the line (15) which runs through the cover (17) and a tubing (20) going from the bottom (18) as far as a nozzle (21), the axial ends of the braid made of a shape-memory material of the hose (T) being electrically connected to the terminals of an electrical power supply.

14. The use of a flexible wall according to one of claims 3 in a hydraulic accumulator, characterized in that the hydraulic accumulator (23) is bounded by a flexible wall (24) and in that opposed edges (24a, 24b) of the ply of wires made of a shape-memory material of this wall are connected to the terminals of an electrical power supply.
